(19) United States
(12) Patent Application Publication
(10) Pub. No.: US 2015/0163874 A1
(43) Pub. Date: Jun. 11, 2015

(54) MULTI-MODE CONTROLLER CIRCUIT

(71) Applicant: General Electric Company, Schenectady, NY (US)

(72) Inventor: Bruce Richard ROBERTS, Mentor on the Lake, OH (US)

(73) Assignee: General Electric Company, Schenectady, NY (US)

(21) Appl. No.: 14/102,536

(22) Filed: Dec. 11, 2013

(51) Int. Cl. H05B 33/08

(52) U.S. Cl. CPC H05B 33/0815

(57) ABSTRACT

Provided is a mechanism for providing a light emitting diode (LED) lighting compatible dimmer. The mechanism includes a detector configured to detect changes in current received from rectified output power and a boost controller responsive to the detecting and providing an operating mode signal to a boost device in accordance therewith. The boost device provides power to a load based upon an operating mode signal including a constant current mode if a current change is detected or enters a power factor control (PFC) mode if the current change is not detected.

### FIELD OF THE INVENTION

The present invention relates generally to dimmer technologies for lighting. More particularly, the present invention relates to dimmer technologies that are compatible with light emitting diode (LED) lighting devices.

### BACKGROUND OF THE INVENTION

LEDs are being increasingly used as a more energy-efficient lighting source over traditional incandescent lamps. One disadvantage of LEDs is that they are much more difficult to control by traditional phase control lighting dimmers as they can be very unstable at low power. In particular, powering LEDs may be difficult or unreliable at certain power levels and in some cases, not possible at all with standard dimmers, when the dimmer control setting is at a low level (or low conduction angle). In order to achieve optimal performance and reliability in LED-based lighting systems, power must be carefully controlled.

Conventional dimmer systems can be based on triode for alternating current (TRIAC) technologies. TRIACs are semiconductor devices used to control the power taken in by an electrical load from an alternating current (AC) power line. They are found in many common applications including light dimmers and motor speed controllers for power tools. As understood by those of skill in the art, a TRIAC is basically an open circuit until it receives a pulse of current into its “gate” terminal. Upon receipt of the pulse of current, it becomes practically a short circuit until the current flowing between its “main terminals” reaches zero. When zero is reached, it then reverts back to an open circuit and remains open until another pulse of gate current occurs.

Phase control dimmer circuits (also referred to as dimming circuits or simply dimmers) are used to control the power provided to a load such as a light or an electric motor from a power source such as main power. These circuits often use a technique referred to as phase control dimming. This allows power provided to the load to be controlled by varying the amount of time that a switch, connecting the load to the power source, is conducting during a given cycle. Circuits that control this process are known in the art as power factor control circuits.

Most power factor control circuits pull current from voltage sources in proportion to the voltage, such that, they behave like a resistor. Therefore power factor control circuits tend to follow the power curve of the input line, which provides a very high power factor, but a variable current. Unfortunately, this not very compatible with LED lighting technologies.

Most LED lighting devices prefer a constant high power current. Therefore, ideally for a dimmer technology controlling an LED load, a square wave current is desirable, such that as the voltages rise and fall, the same amount of current is supplied to the LED load.

### SUMMARY OF EMBODIMENTS OF THE INVENTION

Given the aforementioned deficiencies, a need exists for dimmer control technologies that are more compatible with TRIACs and LED lighting technologies by delivering a constant flow of power while also providing a high power factor. Embodiments of the present invention provide power control circuitry for a dimmer switch that compatible with LED devices.

Under certain circumstances, embodiments of the present invention provide a mechanism for providing a light emitting diode (LED) lighting compatible dimmer. The mechanism includes a detector configured to detect changes in current received from rectified output power and a boost controller responsive to the detecting and providing an operating mode signal to a boost device in accordance therewith. The boost device provides power to a load based upon an operating mode signal including a constant current mode if a current change is detected or enters a power factor control (PFC) mode if the current change is not detected.

In the illustrious embodiments, a phase cut detector logic circuit is provided that operates in conjunction with an adjustable power input source in electrical connection with an AC power rectifier, and a boost controller circuit. The phase cut detector logic circuit detects a gap in the input power source, such as an interruption in voltage and current. Detection of such a change prompts the phase cut detector logic circuit to send a signal to the boost controller circuit for directing the boost controller circuit to switch between a normal power factor correction mode and a constant current mode. This process enables the boost circuit to supply power to an output load having a high power factor and consistent with total harmonic distortion regulatory requirements.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of a block diagram of a multi-mode boost controller circuit constructed in accordance with embodiments of the present invention.

FIG. 2 is a schematic diagram illustration of a multi-mode boost controller logic constructed in accordance with the embodiments.

FIG. 3 is an illustration of a phase cut detector logic circuit constructed in accordance with the embodiments.

FIG. 4 is a flowchart of an exemplary method of practicing an embodiment of the present invention.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

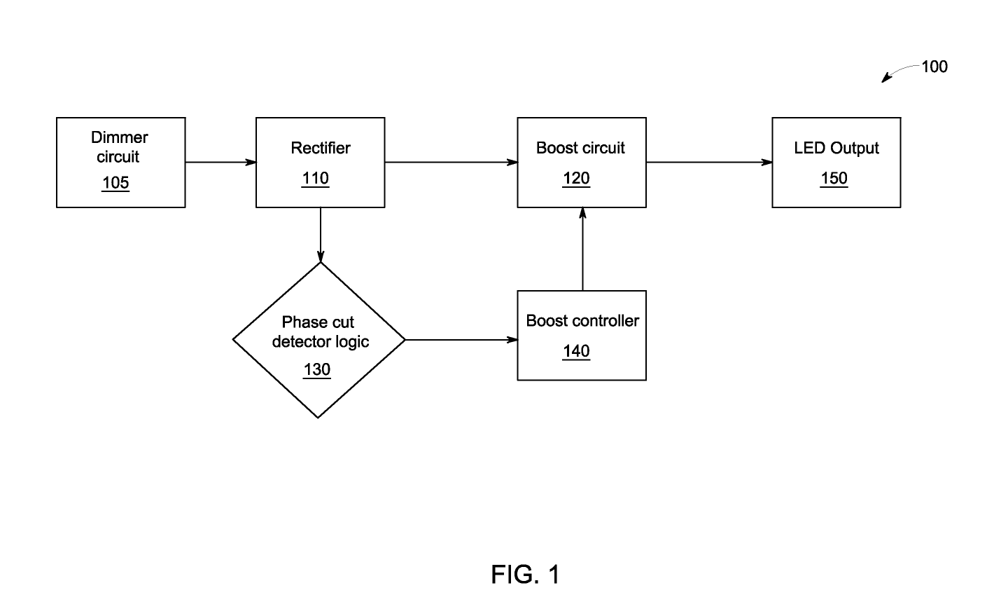

FIG. 1 is a block diagram illustration of a multi-mode boost controller logic circuit 100 according to an embodiment. As noted above, embodiments of the present invention disclose a multi-mode controller logic module 100 that provides an LED compatible dimmer control circuit. The multi-mode boost controller logic 100 includes a power input source 105, a power rectifier 110, a boost circuit 120, phase cut detector logic 130, a boost controller 140, and an LED output device 150.

The input power source 105 can be any AC or direct current (DC) power source, however in the preferred embodiments an AC power line input source is anticipated. In an embodiment, the power input source 105 can be a user phase cut dimmer circuit, as will be understood by the person skilled in the art. Conventional dimmers include TRIACs, which are AC based bidirectional devices, capable of conducting current in either direction once triggered.

The power input source 105 of FIG. 1 provides power to a rectifier 110. The rectifier 110 changes an input AC line to a rectified DC line. Rectifiers are well known in the art, have many uses, and are available in many forms. For power rectification from very low to very high current, semiconductor diodes of various types (junction diodes, Schotty diodes, etc.) are widely used.

The rectifier 110, within a feedback loop including the boost circuit 120, the phase cut detector logic 130 and boost controller 140, supplies the boost circuit 120 and phase cut detector logic 130 with a power input. The boost controller 140 determines the angle at which the boost circuit 120 fires into conduction (the firing or conduction angle), allowing current to flow to the LED output load 150. The output of the boost circuit 120 drives the LED output load 150.

Ultimately, the output of the boost circuit 120 is driven by the user selectable power input source 105 and driven by the feedback loop comprising the phase cut detector logic 130. Therefore, the value of this control signal from the boost circuit 120 may be varied by a user operating a power input source 105.

If the output load is an LED, such as the LED output load 150, then controlling the brightness of the load is difficult if the user sets the power input source 105 too low. This will result in the LED becoming unstable and may flicker, or may not operate at all. The boost circuit 120 is provided for “kick-starting” the LED output load 150 to prevent this instability. Furthermore, the boost controller 140 produces an appropriate boost signal that, in turn, ensures the control signal output from the boost circuit 120 that is sufficiently high to prevent this instability.

In another embodiment, the boost controller 140, triggered by the phase cut detector logic 130, is configured to change modes depending on whether it senses a dimmer voltage signature and/or surge in output current. In normal line input mode, the boost controller 140 operates as a high power factor and low current harmonic distortion controller. This mode is desirable to meet low THD energy rebate requirements and higher power applications. If a dimmer is sensed (by a surge in current) on the input line, the boost controller 140 switches to hysteretic constant input current mode. This mode has a PF of approximately 0.90 and THD of 35% so it does not meet rebate program requirements. It does, however, provide for the largest compatibility with phase cut dimmers because of the constant input current draw.

In the illustrious embodiment depicted in FIG. 1, the phase cut detector logic 130 acts as a sensing circuit—assisting the boost controller 140 to cycle through a power factor (PFC) and a constant current mode. In this manner, the phase cut detector logic circuit 130, the boost controller 140, and the boost circuit 120 cooperatively function to provide power factor correction.

As understood by those of skill in the art, conventional power factor correction circuits pull current from a voltage source in direct proportion to the voltage. They perform similar to a resistor, following the input line, which provides a very high power factor. This process, however, is not very compatible with dimmers, which achieve optimal performance using constant current. In an ideal scenario, for example, the current would be a square wave current, so as the voltage rises and falls, the current would rise and fall similarly.

Embodiments of the present invention provide correction circuits that can achieve optimal performance when interacting with TRIACs as well meet the requirements of a high factor power factor.

In the multi-mode controller logic 100, the phase cut detector logic 130 accounts for changes between a constant current mode and the conventional PFC mode of the boost controller circuit 140. The phase cut detector logic 130 is capable of determining whether a TRIAC exists on the input line. Such a determination is possible because TRIACs interrupt the voltage and current for a portion of each cycle. Thus, the phase cut detector logic 130 senses for such an interruption in voltage and current (e.g. a gap in the input voltage source or a surge in input current).

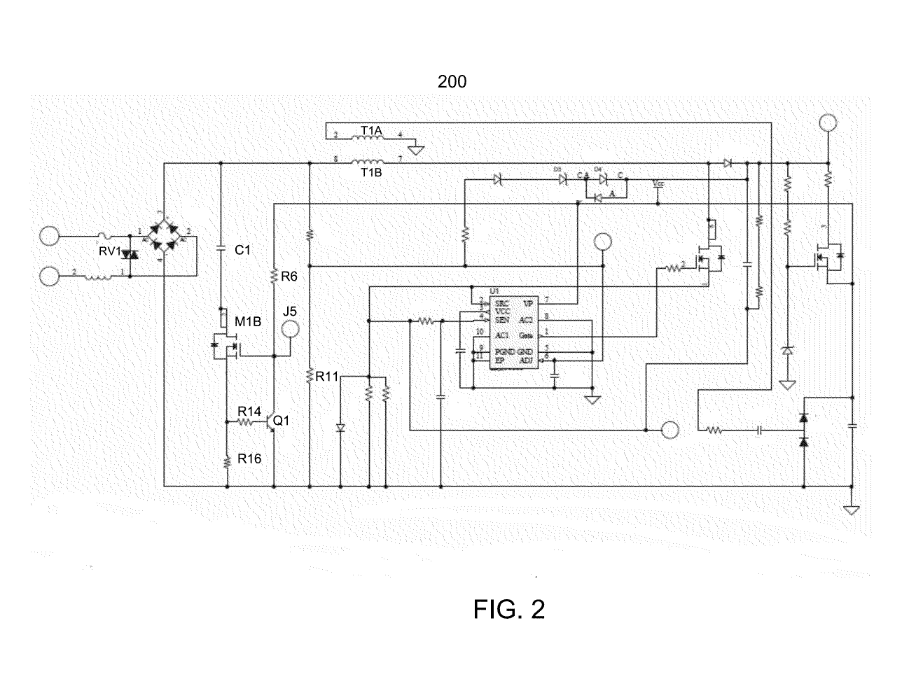

In the embodiment, a trigger pulse at a controlled phase angle in an AC cycle allows one to control the percentage of current that flows through the TRIAC to the load (phase control), which is commonly used, for example, in controlling the brightness of lighting devices (dimmer switch). This trigger pulse causes the forward quadrant of the TRIAC to fire, which releases a surge in current from capacitor C1 of FIG. 2.

This surge in current is an indication to the phase cut detector logic 130, that a TRIAC is controlling current on the power input line. When a TRIAC is determined to be on power input line, the boost controller 140 is switched to a square wave current mode (or constant current mode); wherein a square wave current is used as the power input regardless of what the voltage level on the input line.

More specifically, if there is a gap in the provided input current or power, the detector logic 130 switches to a TRIAC compatible mode. That is, the boot controller 140 switches to the constant current mode (which resembles a square wave current) when the TRIAC is firing and then back to the PFC mode (as the voltage increases, the current increases proportionally) when the TRIAC is no longer firing. This process allows the multi-mode boost controller logic 100 to operate at a high power factor and low current harmonic distortion during normal line input mode. This mode is desirable to meet low total harmonic distortion (THD) or low ripple energy rebate requirements and higher power applications.

FIG. 2 is a schematic representation 200 of the multi-mode boost controller logic associated with the boost controller 140 described above. Normal operation of the multi-mode boost controller is in power factor correction (PFC) mode. In the schematic 200, resistors R6 and R11 are used to shape the output current as a function of the rectified input voltage. Here capacitor C1 is a filter capacitor on the rectified line, which receives user-adjusted current or power via the potentiometer represented by T1A and T1B from the input power source 105.

As the power is adjusted, the TRIAC represented by RV1 responds by attempting to draw more current than normal through capacitor C1. The MOSFET transistor M1B, in coordination with resistors R16, R14 and transistor Q1, work in synchronism to function as a current limiting circuit during the TRIAC event. The current limiting circuit is in electrical connection with the phase cut detector logic circuit 130 at connection point J5.

The phase cut detector logic 130 senses a surge in current from capacitor C1. This surge in current indicates to the phase cut detector logic 130 that a TRIAC exists on the line from the input power source 105. In response, the boost controller 140 is switched to a square wave current mode. This square wave current is used as the power input regardless of what the voltage level on the input line in order to provide a constant smoothed current to the load 150.

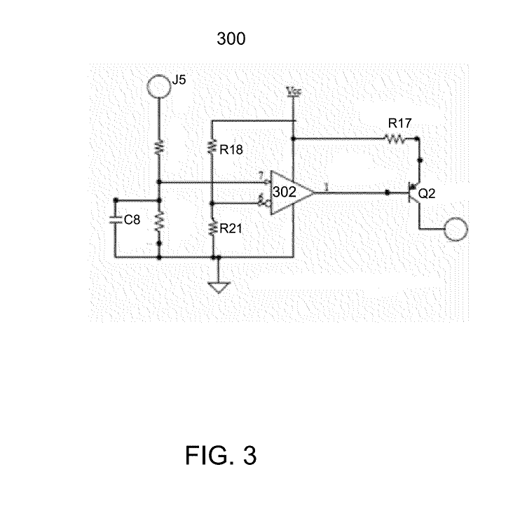

Turing now to FIG. 3, a schematic representation 300 of the phase cut detector logic circuit 130 is illustrated. A simple comparator circuit 302 can represent the phase cut detector logic circuit 130. Here, the comparator 302 receives an adjustable input voltage from the current limiting circuit, noted above, at connection point J5 and compares it to a reference signal from a simple voltage divider circuit represented by resistors R18 and R21 and received at voltage connection point Vcc.

Correspondingly, the phase cut detector logic circuit 130 determines whether current present at the J5 point has been pulled low by the current limiting circuit. The capacitor C8 slowly allows the comparator input to rise again, if no TRIAC events are occurring, to return to normal operation. The output 1 of the comparator 302 drives a transistor Q2 that connects to a low value resistor R17 (e.g., about 10K ohms) from the comparator output to the Vcc, such that smaller inputs are over powered and the boost controller logic 140 is forced to drive the boost circuit into 120 into constant current mode.

Thus, the embodiments disclosed above allow for a hysteretic boost controller 140 that allows for a constant current output from a boost circuit 120 to an LED Output load 150. This allows the boost controller 140 to switch between high power factor PFC mode and constant input current modes depending on whether interruptions in the input current are sensed. These interruptions will occur when a phase cut dimmer or TRIAC (at the input power source 105) is inserted into the circuit.

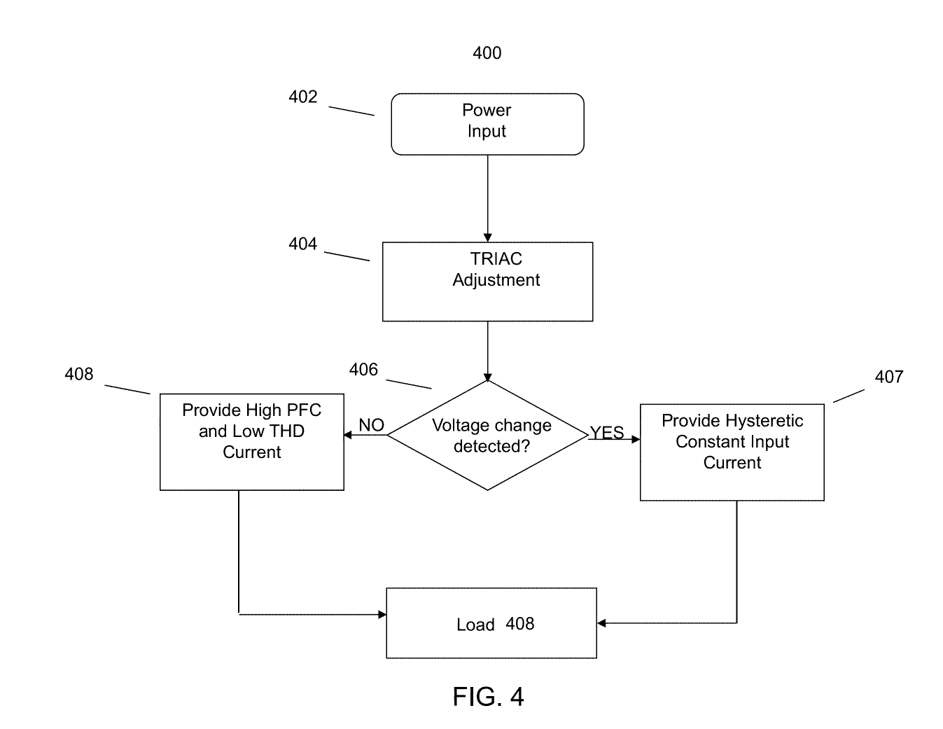

FIG. 4 is a flowchart of an exemplary method 400 of practicing an embodiment of the present invention. FIG. 4, power is applied, for example, at a dimmer circuit in step 402. In step 404, the applied power can be adjusted by adjusting a control on at the dimmer or TRIAC. In step 406, a mechanism, such as the phase cut detector logic 130 discussed above, determines whether a change or surge in current has occurred. If a change has occurred, the boost controller 140 is switched to a constant current mode wherein a constant square-wave current is provided to a load 408, as described above. If a current change has not occurred, as determined in block 406, the boost controller 140 is switched to a conventional PFC mode.

### CONCLUSION

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It is to be appreciated that the Detailed Description section, and not the Summary and Abstract sections, is intended for use in interpreting the claims. The Summary and Abstract sections may set forth one or more but not all exemplary embodiments of the present invention as contemplated by the inventor(s), and thus, are not intended to limit the present invention and the appended claims in any way.

What is claimed is:

1. A mechanism for providing a light emitting diode (LED) lighting compatible dimmer, comprising:
a detector configured to detect changes in current received from rectified output power; and
a boost controller responsive to the detecting and providing an operating mode signal to a boost device in accordance therewith;
wherein the boost device provides power to a load based upon an operating mode signal including a constant current mode if a current change is detected; and
wherein the boost device enters a power factor control (PFC) mode if the current change is not detected.

2. The mechanism of claim 1, wherein the detector circuit is a phase cut detector logic circuit.

3. The mechanism of claim 2, wherein the phase cut detector logic circuit includes a comparator.

4. The mechanism of claim 3, wherein the comparator compares a rectified input current with a reference signal.

5. The mechanism of claim 2, wherein the phase cut detector logic includes a comparator in electrical connection with a capacitor for slowly allowing a comparator input voltage to rise if a change in current is not detected.

6. The mechanism of claim 2, wherein the phase cut detector logic instructs the boost controller to operate at a high power factor with a total harmonic distortion (THD) of less than about 20 percent.

7. The mechanism of claim 2, wherein the boost controller is a fly-back control circuit.

8. The mechanism of claim 2, wherein the rectifier includes a TRIAC.

9. The mechanism of claim 1, wherein the boost controller circuit adjusts the output current between the constant current mode and the PFC mode.

10. The mechanism of claim 1, wherein a boost circuit drives a light emitting diode (LED) electrical load.

11. A mechanism configured to sense the output of a dimmer circuit on an input line for driving a load, the dimmer circuit being configured to adjust an output from a rectified input power line, the mechanism comprising:
a detector logic configured to sense a change in current from the dimmer circuit output; and
a boost controller responsive to the output from the detector logic for adjusting an operating mode signal for a boost circuit for driving the load.

12. The mechanism of claim 11, wherein the operating mode signal includes one of a constant current mode if the current change is sensed or a power factor control (PFC) mode if a current change is not sensed.

13. The mechanism of claim 12, wherein the detector logic is a phase cut detector logic circuit.

14. The mechanism of claim 13, wherein the phase cut detector logic circuit includes a comparator.

15. The mechanism of claim 14, wherein the comparator compares a rectified input voltage with a reference signal.

16. A method for detecting a change in output current from a dimmer circuit, the method comprising:
adjusting output current on a rectified input line;
detecting a current change in the rectified input line and determining whether a TRIAC has fired on the rectified input line based on the change in current; and
adjusting an operating mode signal to the boost circuit based upon the determining;
wherein the operating mode signal includes at least one of a constant current mode if the TRIAC has fired or a power factor control (PFC) mode if the TRIAC has not fired.

17. The method of claim 16, wherein the detecting is performed using a phase cut detector logic circuit.

18. The method of claim 17, wherein the phase cut detector logic circuit includes a comparator.

19. The method of claim 18, wherein the comparator compares a rectified input current with a reference current.

20. The method of claim 18, wherein the comparator compares a rectified input voltage with a reference voltage.
